(19) United States
(12) Patent Application Publication
(10) Pub. No.: US 2004/0068214 A1
(43) Pub. Date: Apr. 8, 2004

(54) Control arrangements for therapeutic inflatable cell apparatus

(76) Inventors: John James Henry Evans, Hampshire (GB); Christopher Peter Evans, Hampshire (GB)

Correspondence Address: BAKER & BOTTS, 30 ROCKEFELLER PLAZA, NEW YORK, NY, 10112

(21) Appl. No.: 10/263,792

(22) Filed: Oct. 3, 2002

(51) Int. Cl. A61H 23/02

(52) U.S. Cl. 601/152

(57) ABSTRACT

A valve arrangement for a pump, the pump being suitable for urging fluid into therapeutic inflatable cell apparatus, the valve arrangement comprising a rotatable valve member (2) provided with at least one fluid passageway (11), the rotatable valve member (2) being adapted to be rotated to predetermined angular positions so as to control fluid quantity in the therapeutic inflatable cell apparatus.

The valve arrangement further comprises a static valve member (3), provided with at least one fluid passageway (14, 15, 16, 17, 18, 19) which is adapted to be communicable with the inflatable cell apparatus and the rotatable valve member (2) being arranged to be rotatable with respect to the static valve member (3) into a position in which said at least one fluid passageway (11) of the rotatable valve member (2) is in fluid communication with the at least one fluid passageway (14, 15, 16, 17, 18, 19) of the static valve member (2).

The present invention relates to control arrangements for therapeutic inflatable cell apparatus and in particular, but not exclusively, to control arrangements for pressure therapy garments.

Pressure therapy garments are adapted to be secured around a specific limb (for example a calf, a thigh or a foot) of a patient. Such garments generally comprise a plurality of inflatable cells which can be inflated/deflated To produce a therapeutic effect and are of particular use in preventing Deep Vain Thrombosis (or DVT). Control of such garments is conventionally effected by a pneumatic pump unit.

It is an object of the present invention to provide improved control of pressure therapy garments.

According to a first aspect of the invention there is provided a valve arrangement for a pump, the pump being suitable for urging fluid into therapeutic inflatable cell apparatus, the valve arrangement comprising a rotatable valve member, said rotatable valve member being provided with at least one fluid passageway and the rotatable valve member being adapted to be rotated to predetermined angular positions so as to control fluid quantity in the therapeutic inflatable cell apparatus.

Preferably where the inflatable cell apparatus comprises a plurality of cells the predetermined angular positions are indexed so that the cells can be selectively inflated.

Preferably the valve arrangement further comprises a static valve member, said static valve member being provided with at least one fluid passageway which is adapted to be communicable with the inflatable cell apparatus and the rotatable valve member being arranged to be rotatable with respect to the static valve member. Most preferably the inflatable valve member is adapted to be rotated into a position in which said at least one fluid passageway of the rotatable valve member is in fluid communication with the at least one fluid passageway of the static valve member.

The rotatable valve member is desirably adapted to be rotated to predetermined angular positions so as to control fluid flow to and from the inflatable cell apparatus.

The rotatable valve member is desirably provided with at least one fluid passageway for inflation of at least part of the inflatable cell apparatus and with at least one fluid passageway for deflation of at least part of the inflatable cell apparatus, and in use the rotatable valve member can be rotated to predetermined angular positions to effect at least one of inflation and deflation of the apparatus.

Most preferably two passageways for inflation are provided which are angularly spaced by 180°.

In a highly preferred embodiment the rotatable valve member is rotatable with respect to the static valve member so as to determine whether a fluid passageway of the static valve member is brought into fluid communication with either an inflation passageway or a deflation passageway of the rotatable valve member.

Preferably the static valve member comprises a plurality of fluid passageways, each fluid passageway being associated with a respective cell of an inflatable cell apparatus.

In a preferred embodiment the static valve member is provided with at least two sets of a plurality of fluid passageways, each set of passageways being adapted to be associated with a respective inflatable cell apparatus.

In preferred embodiments, said fluid passageways of the rotatable valve member and the static valve member extend from one side of the respective valve member to an opposite side of the respective valve member.

Channels are desirably formed in an outer surface in the static valve member, the channels being in fluid communication with fluid passageways of the static valve member, and said channels extending substantially laterally of the fluid passageways.

At least two fluid passageways may be fluidically connected by a channel.

A control arrangement is preferably provided which is adapted to adjust the angular position of the rotatable valve member to a desired angular position in response to a first signal relating to a current angular position, and in response to a second signal relating to angular displacement of the rotatable valve member during movement thereof to the desired angular position.

The control arrangement preferably comprises a sensor and a plurality of index features, the index features being provided at angularly spaced intervals associated with the rotatable valve member, and in use, the sensor being operative to sense the index features.

The control arrangement preferably comprises a data processor, rotation of the rotatable valve member being controlled by the data processor in response to the first and second signals.

According to a second aspect of the invention there is provided a method of controlling fluid quantity in a therapeutic inflatable cell apparatus, the method comprising rotating a rotatable valve member to predetermined angular positions so as to permit at least one of inflation of the inflatable cell apparatus and deflation of the inflatable cell apparatus.

Preferably the rotatable valve member is caused to be rotated in a predetermined sequence. Preferably the predetermined sequence causes at least one part of the therapeutic inflatable cell apparatus to be inflated and then deflated.

It will be appreciated however that in accordance with the present invention control of the fluid quantity in a pressure therapy garment need not necessarily be effected in a sequential manner.

The method most desirably comprises rotating the rotatable valve member to bring at least one fluid passageway of the rotatable valve member into fluid communication with the inflatable cell apparatus.

According to a third aspect of the invention there is provided a connection arrangement for a therapeutic inflatable cell system, the arrangement comprising a plug and a socket, the plug being provided with at least one characteristic feature, said characteristic feature being indicative of a characteristic of the therapeutic inflatable cell apparatus to which the plug is attached, and the socket comprising a sensing arrangement which is adapted to sense the at least one characteristic feature when the plug and socket arrangement is in an interengaged condition.

The at least one character feature may be indicative of the fact that the therapeutic inflatable cell apparatus is designed for a particular part of the body, for example a foot garment.

The at least one characteristic feature may be provided by at least one of the presence and absence of a feature in a predetermined location on the plug.

Preferably the sensing arrangement is in communication with a data processor, the data processor being operable to receive a signal from the sensing arrangement, compare said signal to stored data and determine how fluid quantity in a therapeutic inflatable cell apparatus is to be controlled.

Most preferably a plurality of characteristic features is provided.

A characteristic feature may be provided by a relief formation of a portion of the plug.

The at least one characteristic feature may alternatively or in addition, utilise magnetic, inductive, electrical or optical phenomena.

The sensing arrangement may comprise a switch mechanism, and the at least one characteristic feature determining whether the switch mechanism is switched.

In a preferred embodiment the plug is provided with a plurality of characteristic features, each of which is provided by the relief of each of a plurality of surface portions of the plug, and the sensing arrangement comprising associated switch mechanisms and the relief formation of each surface portion determining whether the associated switch mechanism is switched.

According to a fourth aspect of the invention there is provided a plug for attachment to a therapeutic inflatable cell apparatus, the plug being adapted to be connected to a socket of a fluid pump assembly, the plug being provided with at least one characteristic feature, the at least one characteristic feature being indicative of a characteristic of the inflatable cell apparatus to which the plug is attached and, in use, when the plug is connection to the socket, a sensing arrangement of the socket is arranged to sense the at least one characteristic feature.

According to a fifth aspect of the invention there is provided a socket of a fluid pump assembly suitable for inflating a therapeutic inflatable cell apparatus, the socket being provided with a sensing arrangement, and in use the socket receiving a plug which plug is attached to the therapeutic inflatable cell apparatus, and the sensing arrangement being adapted to sense the at least one characteristic feature with which the plug is provided, the at least one characteristic feature being indicative of a characteristic of the inflatable cell apparatus which is attached to the plug.

According to a sixth aspect of the invention there is provided a method of controlling fluid quantity in therapeutic inflatable apparatus comprising sensing at least one characteristic feature on a connector which is attached to the therapeutic inflatable cell apparatus, the characteristic feature being indicative of a characteristic of the therapeutic inflatable cell apparatus, transmitting a signal to a fluid pump control arrangement and controlling the quantity of fluid in the garment in response to the at least one characteristic feature which was sensed.

According to a seventh aspect of the invention there is provided a control assembly for pump apparatus, the pump apparatus being adapted to control fluid quantity in a therapeutic inflatable cell apparatus, the control assembly comprising a data processor and a data storage device, in use a signal is sent to the data processor from a sensing arrangement which is associated with a socket of the pump apparatus, the socket being adapted to receive a plug which is attached to a therapeutic inflatable cell apparatus, said plug and said socket providing fluid communication between the pump assembly and the therapeutic inflatable cell apparatus, the sensing arrangement generating a signal which is representative of at least one characteristic feature provided on the plug, said characteristic feature being indicative of a characteristic of the inflatable cell apparatus to which the plug is attached the data processor then being operative to compare said signal with data stored in the data storage device and determine how the fluid in the therapeutic inflatable cell apparatus is to be controlled by the pump apparatus.

Preferably the data storage device is provided with predetermined control data. Preferably the control data comprises a plurality of sets of control instructions.

Desirably each set of control instructions is associated with a respective at least one characteristic feature of a plug.

Preferably a set of control instructions causes the pump apparatus to control fluid quantity in a respective inflatable cell apparatus in a predetermined manner.

Conveniently where the data storage device comprises RAM (Random Access Memory) a user may input a desired set of control instructions to be stored by the data storage device.

In a highly preferred embodiment the control assembly determines the type of pressure therapy garment which is connected to the pump apparatus and then controls the pump apparatus to inflate/deflate the garment in accordance with associated stored control instructions.

According to an eighth aspect of the invention there is provided a method of controlling fluid quantity in therapeutic inflatable cell apparatus comprising measuring fluid pressure in at least part of the therapeutic inflatable cell apparatus and controlling the fluid quantity in response to pressure which has been measured.

According to a ninth aspect of the invention there is provided control assembly for a therapeutic inflatable cell apparatus, the assembly comprising a pressure sensor, a data processor and a fluid control assembly, the data processor being configured to receive a feedback signal from the pressure sensor which is representative of a measurement of fluid pressure in a therapeutic inflatable cell apparatus, and said data processor being further configured to emit a control signal in response to the feedback signal, the control signal being sent to the fluid control assembly which is operative to control fluid quantity in the therapeutic cell apparatus.

Various embodiments of the invention will now be described, by way of example only, with reference to the accompanying drawings in which:

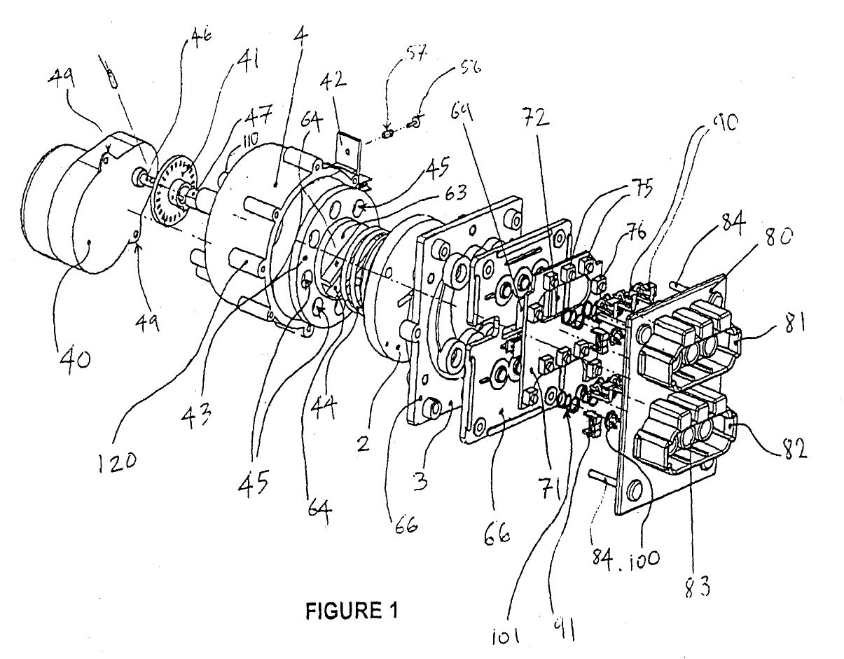

FIG. 1 is an exploded front isometric view of part of pneumatic pump assembly in accordance with the invention,

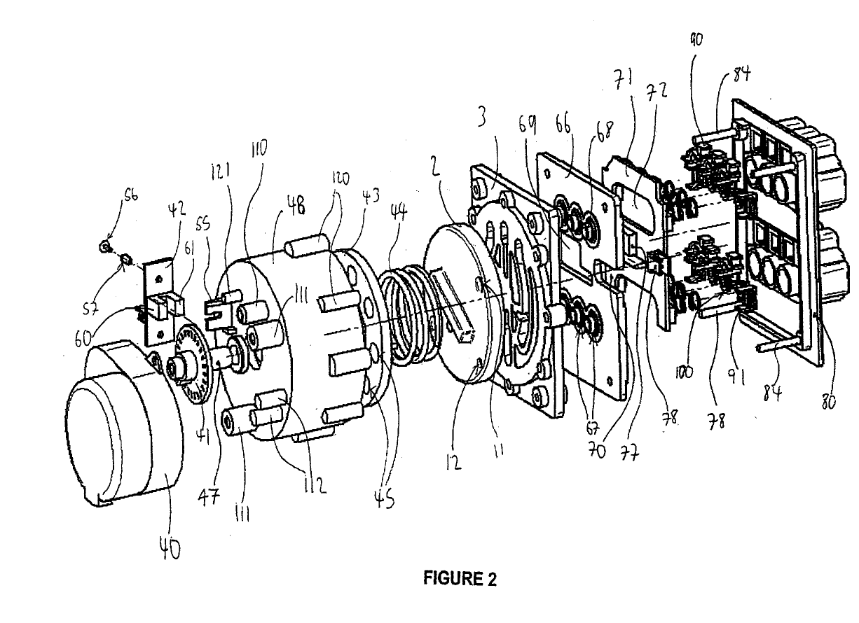

FIG. 2 is an exploded rear view of the part of the pneumatic pump assembly shown in FIG. 1,

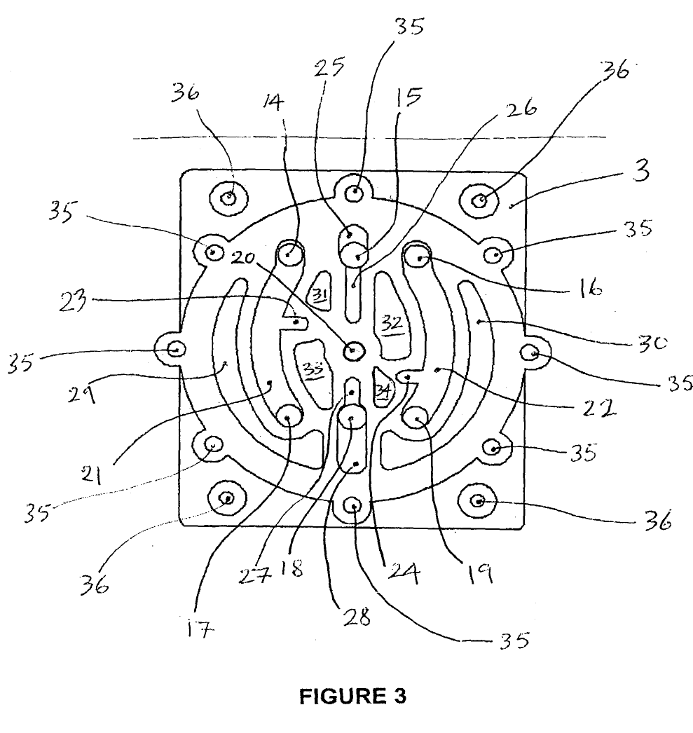

FIG. 3 is a rear elevation of the static valve member shown in FIGS. 1 and 2,

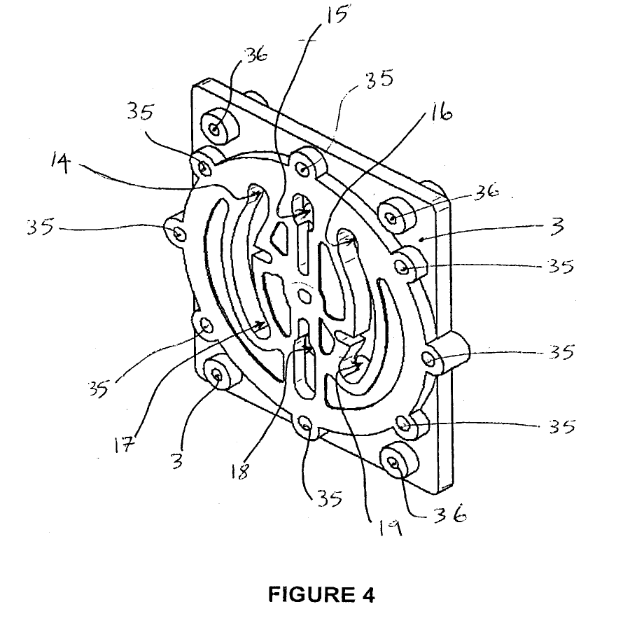

FIG. 4 is a rear isometric view of the static valve member shown in FIG. 3,

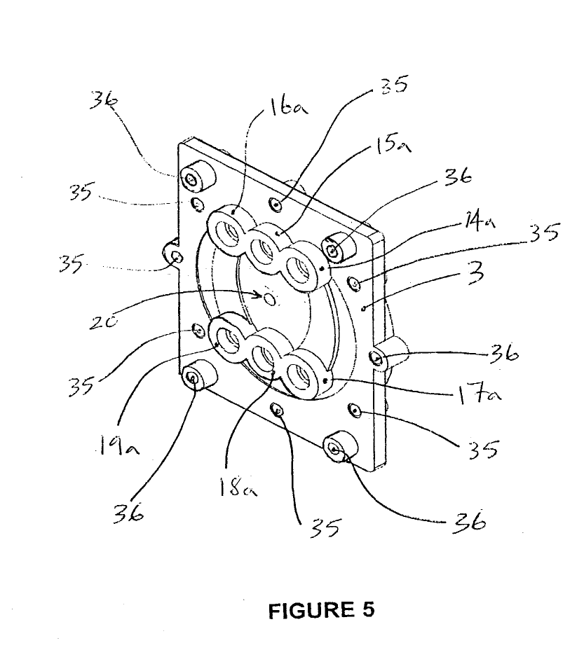

FIG. 5 is a front isometric view of the static valve member shown in FIGS. 3 and 4,

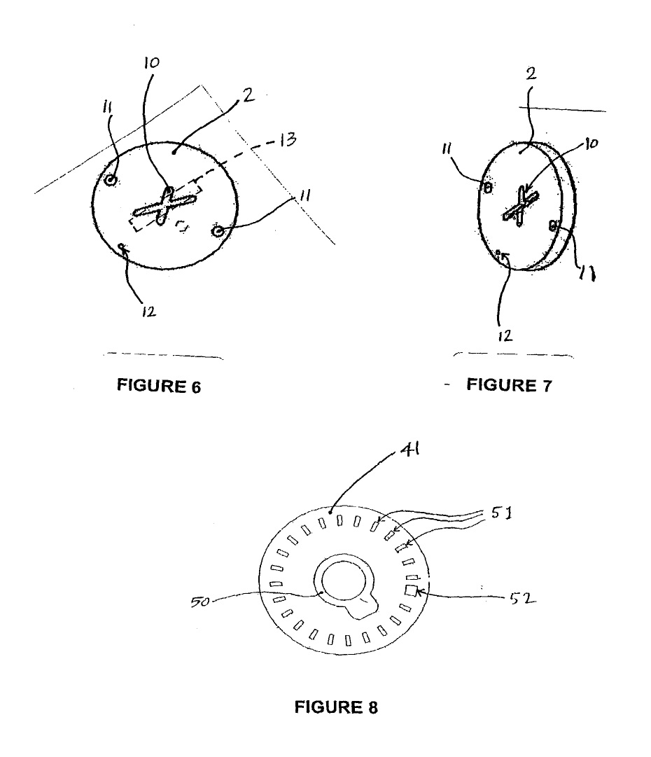

FIG. 6 is a front elevation of the rotatable valve member shown in FIGS. 1 and 2,

FIG. 7 is a front isometric view of the rotatable valve member shown in FIG. 6,

FIG. 8 is a front elevation of the optical disc shown in FIGS. 1 and 2,

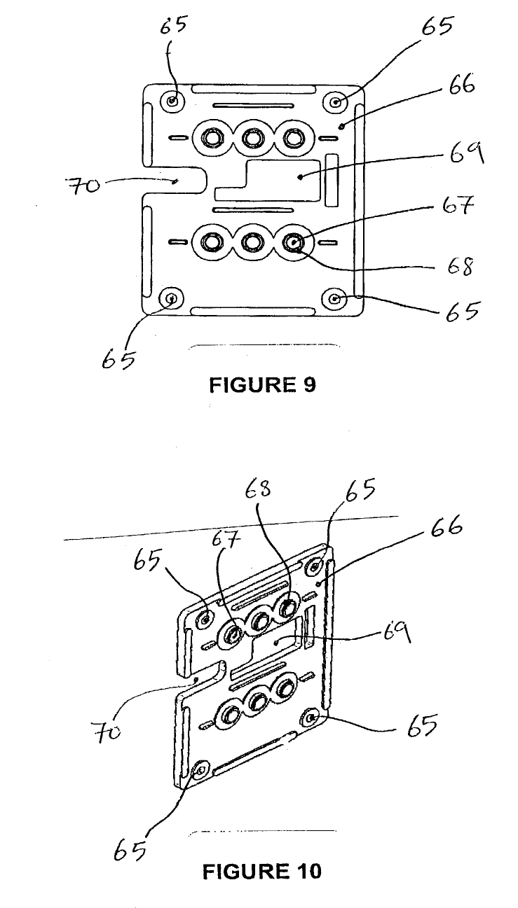

FIG. 9 is a front elevation of the intermediate plate shown in FIGS. 1 and 2,

FIG. 10 is a front isometric view of the intermediate plate shown in FIG. 9,

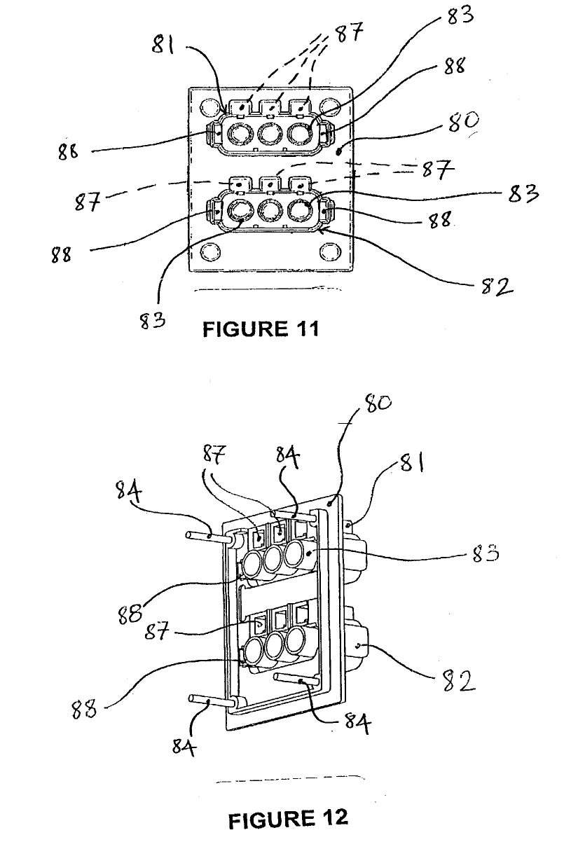

FIG. 11 is a front elevation of the connector plate shown in FIGS. 1 and 2,

FIG. 12 is a rear isometric view of the connector plate shown in FIG. 11,

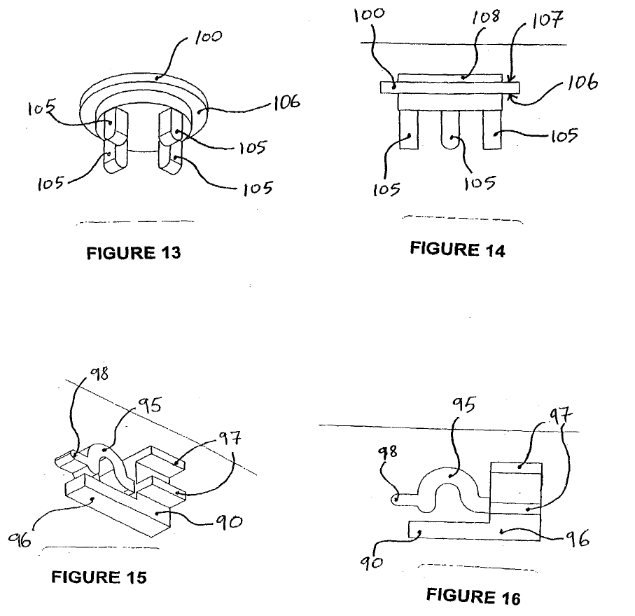

FIG. 13 is an isometric view of a non-return valve shown in FIGS. 1 and 2,

FIG. 14 is a side elevation of the non-return valve shown in FIG. 13,

FIG. 15 is an isometric view of a switch actuator shown in FIGS. 1 and 2,

FIG. 16 is a side elevation of the switch actuator shown in FIG. 15,

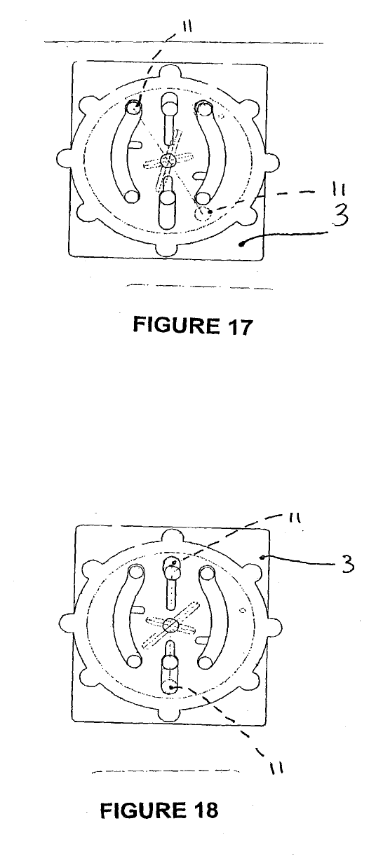

FIG. 17 is a rear elevation of the static valve member onto which the outline of the rotatable valve member in a first position has been superimposed,

FIG. 18 is similar to FIG. 17 with the rotatable valve member shown in a second position,

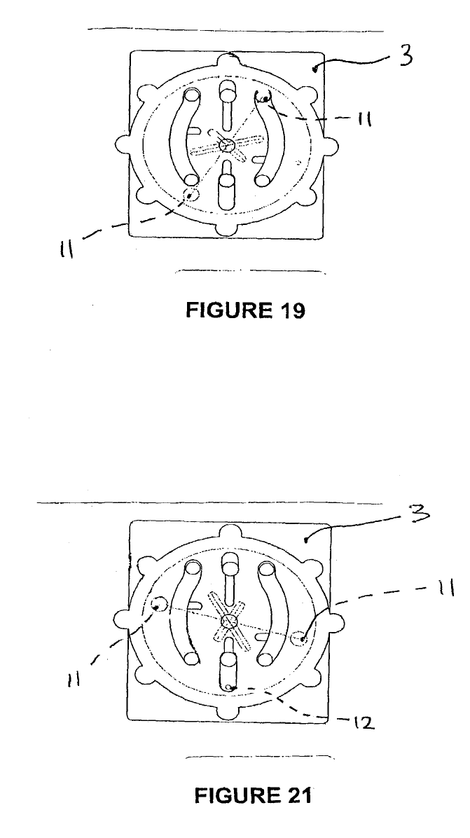

FIG. 19 is similar to FIGS. 17 and 18 with the rotatable valve member in a third position,

FIG. 20 is similar to FIGS. 17, 18 and 19 with the rotatable valve member shown in a fourth position,

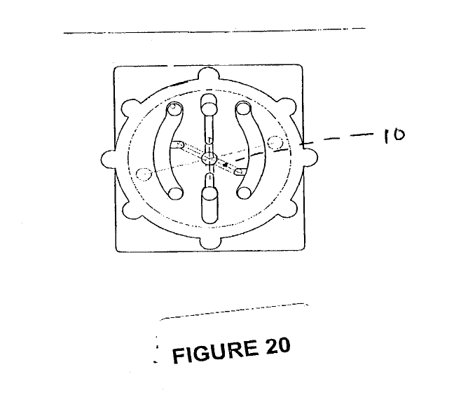

FIG. 21 is similar to FIGS. 17, 18, 19 and 20 with the rotatable valve member shown in a fifth position,

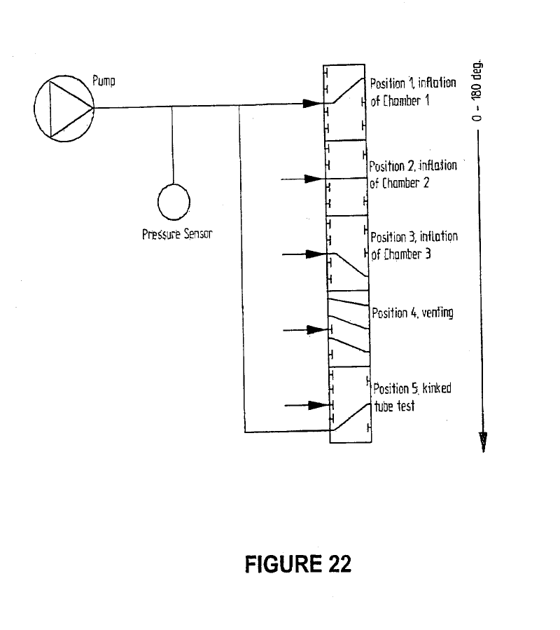

FIG. 22 is a schematic representation of the various predetermined angular positions of the rotatable valve member,

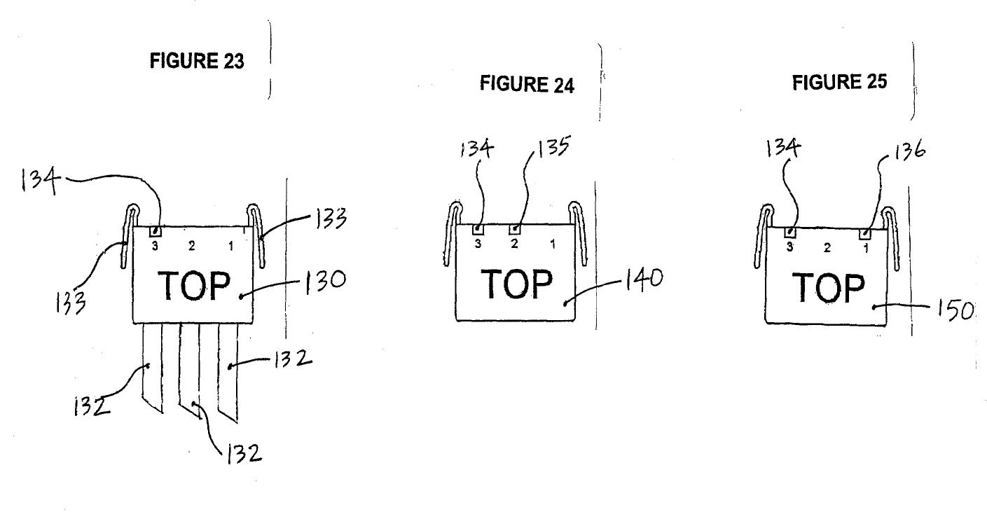

FIG. 23 is a plan view of a plug of a first pressure therapy garment,

FIG. 24 is a plan view of a plug of a second pressure therapy garment,

FIG. 25 is a plan view of a plug of a third pressure therapy garment,

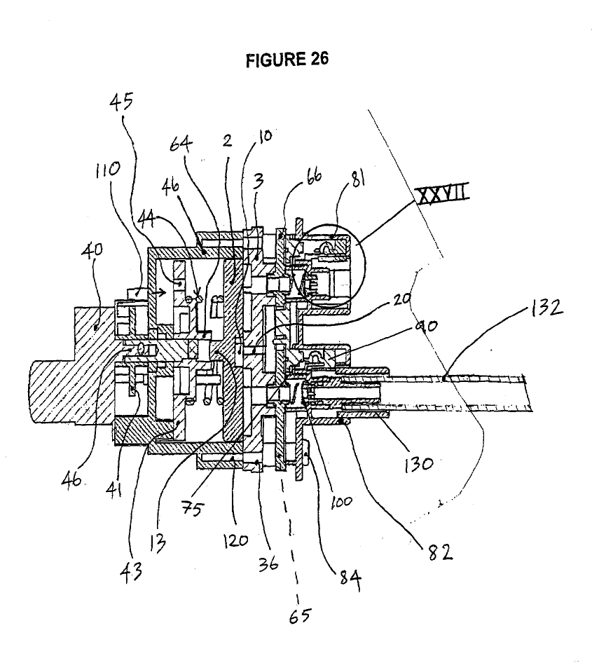

FIG. 26 is a (somewhat schematic) cross-section of the components shown in FIGS. 1 and 2 in an assembled state in which one plug has been inserted into one of the sockets of the connector plate,

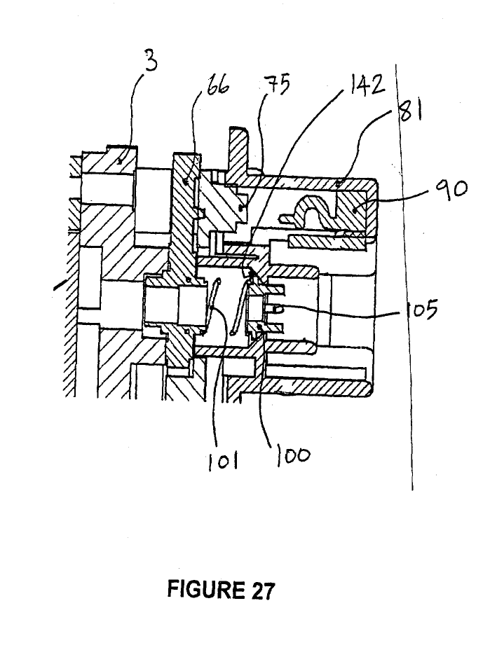

FIG. 27 is an enlarged view of a socket indicated by the enclosed region of FIG. 26, and

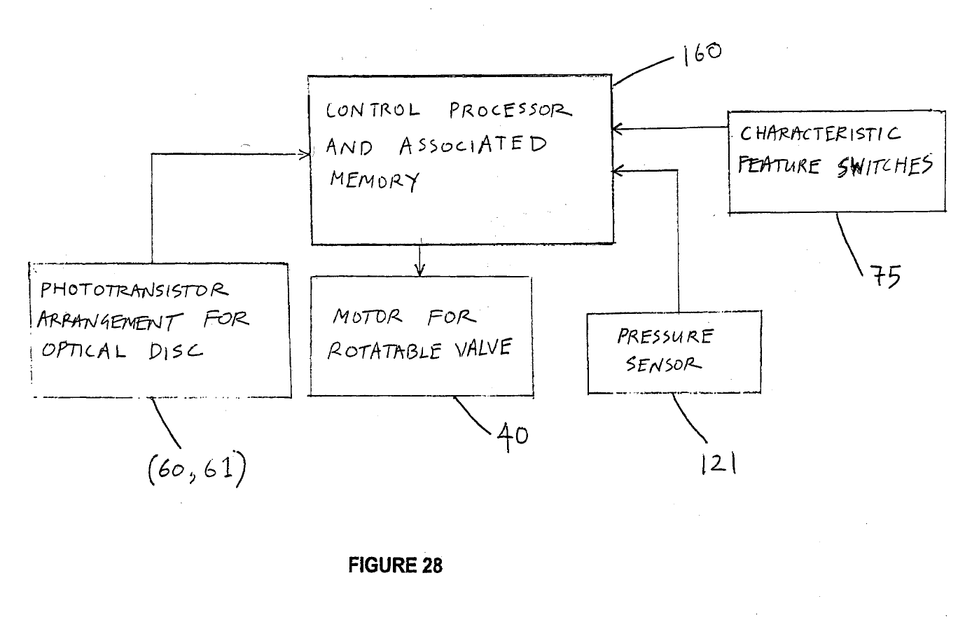

FIG. 28 is a block diagram of various control components of the pneumatic pump assembly.

With reference to FIGS. 1 and 2 there are shown various components of part of a pneumatic pump assembly for pressure therapy garments as hereinbefore discussed, said components forming a valve arrangement and part of a connection arrangement as will now be further described. Although not shown in the drawings the pneumatic pump assembly is a portable unit which is provided with a control panel comprising a key pad and a display screen for a user of the unit.

The valve arrangement comprises a rotatable valve member 2, a static valve member 3, the rotatable valve member 2 being arranged to be rotatable with respect to the static valve member 3.

With further reference to FIGS. 6 and 7 the rotatable valve member 2 is of disc-like form and is provided with a ‘blind’ recess 10 of substantially skewed X-shape which is formed in the front surface thereof. The valve member 2 further comprises two through-holes 11 forming fluid passageways which are angularly spaced by 180° about the centre point of the valve member 2.

A third though-hole 12 is provided in the rotatable valve member 2 of which the angular separation from each of the holes 11 is 75° in each case.

The rearward surface of the rotatable valve member 2 is provided with rib 13 which extends in a direction which is substantially parallel to the diameter of the valve member.

With reference in particular to FIGS. 3, 4 and 5 the static valve member 3 is essentially of plate like form and is provided with a first set of horizontally aligned ports 14, 15 and 16 and a second set of horizontally aligned ports 17, 18 and 19, said ports providing fluid passageways. A port 20 is also provided in the static valve member 3 which is located substantially centrally of said valve member.

As seen best in FIGS. 5 and 6 channels 21 and 22, which are of substantially arcuate outline, provide fluid communication between ports 14 and 17, and ports 16 and 19 respectively. The channels 21 and 22 are provided with branch channel positions 23 and 24 respectively which extend substantially horizontally towards the vertical axis of the static valve member 3.

The ports 15 and 18 which are located centrally of each set of ports are each provided with upper and lower channel portions which are in fluid communication with the respective port. The port 15 is provided with an upper channel portion 25 and a lower channel portion 26, and the port 18 being provided with upper channel portion 27 and lower channel portion 28.

The rearward face of the static valve member 3 is also provided with a plurality of pressure relief recesses 31, 32, 33 and 34.

Turning to FIG. 5 showing the front face of the static valve member 6 each port 14, 15, 16, 17, 18 and 19 there is an associated outwardly extending annular wall 14a, 15a, 16a, 17a, 18a and 19a respectively.

Equally angularly spaced around the ports 14, 15, 16, 17, 18, 19 and 20 and arranged in a circular formation, a first set of eight attachment through-holes 35 are provided. The static valve member 3 is also provided with a second set of four attachment through-holes 36 which are located towards the corners of the valve member 3.

The assembly further comprises a motor 40, an optical disc 41, a sensor 42, a transmission disc 43 and a spring 44.

The motor 40 comprises an output shaft portion 46 onto which is rotatably mounted the optical disc 41. The shaft portion 46 is received in a collar 47 and is fast with the optical disc 41. The collar 47 passes through the disc 41 and through two sleeves 50 which are provided on opposite sides of the disc 41. The shaft portion 46 extends through an aperture in cylindrical housing 48 and the distal end of said collar 47 is fixedly attached to the rearward face of the transmission disc 43.

The optical disc 41 is provided with twenty three slots 51 and one slot 52, the slots 51 and 52 are angularly spaced around the disc 41 and the slot 52 being slightly wider than the slots 52.

A sensor device 42 is attached to bracket 55 by way of a two-piece fastener arrangement shown at 56 and 57. The sensor device may generally be described as a phototransistor device which comprises two limbs 60 and 61 which are spaced such that in use they flank the optical disc 41. The limb 60 is provided with an inwardly directed light emitting device (not shown) and the limb 61 is provided with a light sensor (not shown) which is directly opposite the light emitting device.

The transmission disc 43 is provided with eight equally angularly spaced ports 45 and comprises a locating formation 63 on the front face thereof. The locating formation 63 comprises two spaced walls 64 which are adapted to receive the rib 13 of the rotatable valve member 2.

The spring 44 is adapted to fit over the locating formation 63 and the rib 13 and so be interposed between the transmission disc 43 and the rotatable valve member 2.

Located adjacent to the front face of the static valve member 3 there is provided an intermediate plate 66. The intermediate plate 66 is provided with two sets of three ports 67 which are arranged to correspond with the arrangement of the ports 14, 15, 16, 17, 18 and 19 of the static valve member 3. Each port 67 comprises an outwardly extending conduit portion 68 on front and rear faces of the intermediate plate 66.

The intermediate plate 66 is provided with two cut-outs 69 and 70 which are located generally between the two sets of ports 67. The intermediate plate is further provided with four attachment holes 73 which are located towards each corner of the plate.

Moving further forward there is provided a switch plate 71. The plate 71 is provided with two cut-outs 72 and 73 which are dimensioned to accommodate the conduit ports 68 of the intermediate plate 66. On the front face of the switch plate a set of three switch buttons 75 are provided above each cut-out 72 and 73, and two further switch buttons 76 are provided on each side of each cut-out. The buttons 75 and 76 are electrically connected to a printed circuit board component 77 which is fixed to the rear face of the switch plate 71. A connector 78 permits electrical connection of the component 77 to further components.

The connector plate 80 comprises two socket formations 81 and 82 which are each adapted to receive one of the garment plugs as shown in any of FIGS. 23, 24 and 25. Each socket formation 81 and 82 comprises three connection conduits 83 each of which, in use, corresponds to an associated inflatable cell or cells of a pressure therapy garment.

The socket formations 81 and 82 each comprise three switch actuators 90 which are slidably mounted in slots 87 which are situated above each connection conduit 83. Furthermore each formation 81 and 82 also comprises two actuators 91 which are slidably mounted in slots 89 which are situated on each side of each socket formation.

With reference to FIGS. 15 and 16 in particular, each switch actuator 90 comprises a resilient finger 95, a base 96 and two pairs of location walls 97, the finger 95 being provided with a tip 98 at the rearward end thereof.

The rearward ends of the conduits 83 are each provided with a non-return valve arrangement which comprises a valve plate 100 and a spring 101. The valve plates 100 each comprise four guide limbs 105 which are configured to be received in a respective conduit 83.

A front facing annular shoulder 106 is provided around the guide limbs 105 and is axially spaced from the bases thereof. In use the shoulder 106 receives an o-ring seal (omitted from FIGS. 13 and 14).

The valve plate 100 is provided on the rear facing surface thereof with an annular shoulder 107 which is adapted to locate one end of the respective spring 101.

FIGS. 26 and 27 show the components of FIGS. 1 and 2 in an assembled state. As is evident fasteners 84 are passed through aligned attachment holes 65, 36 of the intermediate plate 66 and the static valve member 3 respectively and into respective blind bores 120 of the housing 48. The transmission disc, the spring 44 and the rotatable valve member 2 are thus contained within the housing 48. The action of the spring 44 is to cause the rotatable valve member 2 to resiliently bear against the rearward face of the static valve member 3 and be in fluid sealing engagement therewith.

In use the apparatus operates as follows. A pressure therapy garment (not shown) is connected to the apparatus (shown in FIG. 26) which is provided in a portable pneumatic pump unit (not shown). This is effected by inserting a plug 130 into one of the socket formations 81 or 82. The plug is connected to the garment by way of three flexible plastic tubes 132 which provide fluid communication with respective cells of the garment.

In FIG. 26 the plug 130 is shown inserted into the socket 82. As can be seen from FIG. 22 the uppermost surface of the plug 130 is provided with a notch 134 in position 3. On connecting the plug 130 the fact that there is notch at position 2 will cause that portion of the plug to engage with the base 96 of the respective switch actuator 90 to move rearwardly and for the tip 98 of the finger 95 to depress the respective button switch 75. However, the switch button 75 associated with position 3 of the plug 130 will not be depressed since the notch 134 allows the plug to be inserted without the associated switch actuator 90 to be urged rearwardly and thus depress the respective Switch button 75.

Accordingly, the presence or omission of slots in predetermined positions on a garment plug is used to provide characteristic information about the type of garment to which the plug is attached. Depending on which button switches 75 are depressed a signal is produced which is indicative of the garment type. The signal is sent to a control printed circuit board (not shown) via the component 77 and the connection 78 which can compare the received signal with stored characteristic data, and control the inflation/deflation of a garment accordingly.

With reference to FIG. 28 there is shown at 160 a data processor (or central processing unit) and an associated memory which are provided on the control printed circuit board. The memory has stored therein characteristic data (which corresponds to characteristic feature/s of the plug of a therapy garment) and associated inflation/deflation control instructions. In practice the data processor is programmed with software which contains predetermined control protocols and instructions, and some predetermined characteristic data.

By way of explanation it may be that the plug shown in FIG. 22 is attached to a foot garment the plug 140 of FIG. 23 may be attached to a thigh garment and the plug 150 of FIG. 24 may be attached to a calf garment.

The plug 130 is provided with two sprung clips 133 which cause the two switch actuators 91 to be urged in a rearward direction and cause the respective switch buttons to be depressed. The resulting signal sent to the control arrangement of the pump unit indicates merely that a plug has been inserted into the particular socket 81 or 82.

As is seen best in FIG. 26 inner conduits 131 of the plug 130 engage with the limbs 105 of the respective valve plates 100 and urge said valve plates in a rearward direction against a resilient force of the associated springs 101 thus providing fluid communication between the inflatable cells of the garment and the ports 14, 15, 16, 17, 18 and 19 of the static valve member 3.

With reference to FIG. 27 when the valve plates 100 act to seal the conduits 83 said valve plate is seated on a chamfered shoulder 142.

An inflation/deflation cycle of a pressure therapy garment will now be described with reference in particular to FIGS. 17, 18, 19, 20 and 21.

As previously described the optical disc 41 enables the angular position of the rotatable valve member to be determined. The slot 52 is wider than the other slots 51 so as to indicate 0° position. As the optical disc is rotated the disc 41 will periodically block light from reaching the light detecting device provided on the limb 61 and will result in a signal that is effectively a square wave. Thus the slot 52 will produce a ‘pulse’ of longer duration which is indicative of 0° position and the number of subsequent pulses produced by the narrower slots 51 will determine the angular displacement from the 0° position. Since twenty four slots are provided the optical disc 41 enables a resolution of 15°. Signals from the sensor arrangement 42 are sent to the data processor of the control printed circuit board and the rotatable valve member is rotated to a desired angular position in response to stored information as to a current angular position and the (feedback) signal received from the sensor arrangement 42 as the optical disc is rotated.

A pressurised air inlet 110 is connected to a pneumatic pump (see FIG. 22), such that in use air is urged into the housing 48.

The rotatable valve member 2 is initially rotated to 75° from the 0° position as shown in FIG. 17. In this position air is able to pass through one of the ports 11 and into port 14 of static valve member 3 and into port 16 of the same by virtue of the channel 21, A pressure sensor (not shown) monitor the pressure of air in each of the conduits 83 which pressure measurements correspond to the pressure in the respective cells of a garment. It is important to note that the inflation time (i.e. the time for which the rotatable valve member 2 is held in a particular position) is dependent on the pressure measurements and not on a predetermined time. Signals indicative of the pressure readings are sent to the data processor of the control printed circuit board of the pump assembly from the pressure sensor which is located in an outlet port 121 (see FIG. 2), in the housing 46.

Once the predetermined pressure is reached the rotatable valve member is rotated to the 105° position shown in FIG. 18 so that one of the ports 11 is brought into alignment with the upper channel 25 and the other port 11 is brought into alignment with the lower channel 28. In such a position air is caused to inflate the cells which are in communication with the parts 15 and 18.

FIG. 19 shows the rotatable valve member in the 135° position in which the cells in communication with ports 16 and 19 of the static valve member 3 are inflated. The port 19 receives a supply of air via the channel 22.

The rotatable valve member is then rotated into the 180° position in which the blind recess 10 is brought into fluid communication with the branch channel portions 23 and 24 and the lower channel 26 and the upper channel 27. In such a position the ports 14, 15, 16, 17, 18 and 19 are brought into fluid communication with the aperture 20 via the recess 10. The aperture 20 is open to atmosphere and thus all the cells of both garments are deflated. The deflation process is similarly controlled in response to pressure measurements as described above.

Two further positions of the rotatable valve member 2 are attainable, one of which is shown in FIG. 21. The port 12 is brought into alignment with the lower channel 28 so as to perform a so called kinked tube test on the centrally located connection tube between a plug in the lower socket 82 and the respective garment. If pressures above a predetermined level are measured in a selected conduit 83 then the data processor causes an alarm signal to be activated.

A further kinked tube test is also effected for the connection tube in communication with the port 15.

As should now be evident one rotation through 360° of the rotatable valve member 2 results in two inflation/deflation cycles.

Various technical specifications of a preferred embodiment of the pneumatic pump assembly are as follows.

Performance

| | |
|---|---|
| Leakage | <1 mmHg per second at 160 mmHg |
| Minimum cycle time | 10 seconds. |
| Nominal Cycle Time | 75 seconds. |

The design allows for two actual cycles per rotation of the rotor.

Cell Inflation Time

| | |
|---|---|
| Foot Garment | 10-20 seconds |
| Calf Garment | 10-20 seconds |
| Thigh Garment | 10-20 seconds |

Cell Deflation Time 15-45 seconds

Max. Number of Cells 3

Max. Number of Garments 2

(Note Foot garments may not be mixed with other types.)

Air Pressures

| Calf Garment | 40 to 60 | mmHg. |
|---|---|---|
| Thigh Garment | 40 to 60 | mmHg |
| Legs (one Calf + one Thigh) | 40 to 60 | mmHg |
| Foot Garment | 120 | mmHg |

Set Pressure Determined by operation of front panel keys of control arrangement to increase or decrease the value set by the user

Gradient Pressure

Not applicable to foot garment

cell 1 is at set pressure.

cell 2 is at −1/16 set pressure.

cell 3 is at −1/16 cell 2 set pressure

| | |
|---|---|
| Initial Setting | Setting from previous session if also previous |
| | garment mode. |
| | 45 mmHg if new garment mode selected. (not |
| | foot) |
| Pressure Sensor | The circuit is calibrated without use of any |
| | pre-sets. |
| | 0 mmHg and the reference pressure of |
| | 160 mmHg only are measured. |

Low Pressure Testing

No testing during the first cycle.

Testing occurs over the complete cell inflate period. Values detect 12 mm split.

Alarm if measured cell pressure never exceeds the threshold value during cell inflation period.

Calf Garments

Threshold pressure for cell 1 is min of 20 mmHg or ¾ set pressure.

Threshold pressure for cell 2 is min of 20 mmHg or ¾ grad pressure. Threshold pressure for cell 3 is min of 20 mmHg or ¾ grad pressure.

Thigh Garments

Threshold pressure for cell 1 is min of 20 mmHg or ¾ set pressure.

Threshold pressure for cell 2 is min of 20 mmHg or ¾ grad pressure. Threshold pressure for cell 3 is min of 20 mmHg or ¾ grad pressure.

Foot Garments

Threshold pressure for cell 1 is min of 20 mmHg or ¾ set pressure.

Threshold pressure for cell 2 is min of 20 mmHg or ¾ grad pressure. Threshold pressure for cell 3 is min of 20 mmHg or ¾ grad pressure.

As is now evident the present invention allows much greater versatility of control the inflation and deflation of a pressure therapy garment. In alternative embodiments within the scope of the invention the fluid passageways of the rotatable valve member 2 and the static valve member 3 may be designed, for example, to allow for garments with more than three cells to be controlled, or alternatively or in addition, to allow individual selective inflation or deflation of some or all of the cells of an individual garment independently of the cells of another/other garments.

In one embodiment of the invention the rotatable valve member and the static valve member arc configured such that inflation and deflation is controlled by rotation of a single fluid passageway provided in the rotatable valve member.

The rotary control of the valve arrangement permits for various types of control including sequential, gradient sequential or peristaltic sequential.

1. A valve arrangement for a pump, the pump being suitable for urging fluid into therapeutic inflatable cell apparatus, the valve arrangement comprising a rotatable valve member provided with at least one fluid passageway, the rotatable valve member being adapted to be rotated to predetermined angular positions so as to control fluid quantity in the therapeutic inflatable cell apparatus.

2. The valve arrangement of claim 1 wherein the inflatable cell apparatus comprises a plurality of cells the predetermined angular positions are indexed so that the cells can be selectively inflated.

3. The valve arrangement of claim 1 wherein the valve arrangement further comprises a static valve member, said static valve member being provided with at least one fluid passageway which is adapted to be communicable with the inflatable cell apparatus and the rotatable valve member being arranged to be rotatable with respect to the static valve member.

4. The valve arrangement of claim 3 wherein the inflatable valve member is adapted to be rotated into a position in which said at least one fluid passageway of the rotatable valve member is in fluid communication with the at least one fluid passageway of the static valve member.

5. The valve arrangement as claimed in claim 1 wherein the rotatable valve member is adapted to be rotated to predetermined angular positions so as to control fluid flow to and from the inflatable cell apparatus.

6. The valve arrangement of claim 5 wherein the rotatable valve member is provided with at least one fluid passageway for inflation of at least part of the inflatable cell apparatus and with at least one fluid passageway for deflation of at least part of the inflatable cell apparatus, and in use the rotatable valve member can be rotated to predetermined angular positions to effect at least one of inflation and deflation of the apparatus.

7. The valve arrangement of claim 6 wherein two passageways for inflation are provided which are angularly spaced by 180°.

8. The valve arrangement of claim 6 wherein the rotatable valve member is rotatable with respect to the static valve member so as to determine whether a fluid passageway of the static valve member is brought into fluid communication with either an inflation passageway or a deflation passageway of the rotatable valve member.

9. The valve arrangement of claim 3 wherein the static valve member comprises a plurality of fluid passageways, each fluid passageway being associated with a respective cell of an inflatable cell apparatus.

10. The valve arrangement of claim 9 wherein the static valve member is provided with at least two sets of a plurality of fluid passageways, each set of passageways being adapted to be associated with a respective inflatable cell apparatus.

11. The valve arrangement of claim 3 wherein fluid passageways of the rotatable valve member and the static valve member extend from one side of the respective valve member to an opposite side of the respective valve member.

12. The valve arrangement of claim 3 wherein channels are formed in an outer surface in the static valve member, the channels being in fluid communication with fluid passageways of the static valve member, and said channels extending substantially laterally of the fluid passageways.

13. The valve arrangement of claim 12 wherein at least two fluid passageways are fluidically connected by a channel.

14. The valve arrangement of claim 1 wherein a control arrangement is provided which is adapted to adjust the angular position of the rotatable valve member to a desired angular position in response to a first signal relating to a current angular position, and in response to a second signal relating to angular displacement of the rotatable valve member during movement to the desired angular position.

15. The valve arrangement of claim 14 wherein the control arrangement comprises a sensor and a plurality of index features the index features being provided at angularly spaced intervals associated with the rotatable valve member, and in use, the sensor being operative to sense the index features.

16. A method of controlling fluid quantity in a therapeutic inflatable cell apparatus, the method comprising rotating a rotatable valve member to predetermined angular positions so as to permit at least one of inflation of the inflatable cell apparatus and deflation of the inflatable cell apparatus.

17. The method of claim 16 wherein the rotatable valve member is caused to be rotated in a predetermined sequence.

18. The method of claim 17 wherein the predetermined sequence causes at least one part of the therapeutic inflatable cell apparatus to be inflated and then deflated.

19. The method of claim 16 comprising rotating the rotatable valve member to bring at least one fluid passageway of the rotatable valve member into fluid communication with the inflatable cell apparatus.

20. A connection arrangement for a therapeutic inflatable cell system, the arrangement comprising a plug and a socket, the plug being provided with at least one characteristic feature, said characteristic feature being indicative of a characteristic of the therapeutic inflatable cell apparatus to which the plug is attached, and the socket comprising a sensing arrangement which is adapted to sense the at least one characteristic feature when the plug and socket arrangement is in an inter-engaged condition.

21. The connection arrangement of claim 20 wherein the at least one characteristic feature is provided by at least one of the presence and absence of a feature in a predetermined location on the plug.

22. The connection arrangement of claim 20 wherein a plurality of characteristic features is provided.

23. The connection arrangement of claim 20 wherein a characteristic feature is provided by a relief formation of a portion of the plug.

24. The connection arrangement of claim 20 wherein the characteristic feature utilises magnetic phenomena.

25. The connection arrangement of claim 20 wherein the characteristic feature utilises inductive phenomena.

26. The connection arrangement of claim 20 wherein the characteristic feature utilises electrical phenomena.

27. The connection arrangement of claim 20 wherein the characteristic feature utilises optical phenomena.

28. The connection arrangement of claim 20 wherein the sensing arrangement comprises a switch mechanism, and in use the at least one characteristic feature determining whether the switch mechanism is switched.

29. The connection arrangement of claim 28 wherein the plug is provided with a plurality of characteristic features, each of which is provided by the relief of each of a plurality of surface portions of the plug, and the sensing arrangement comprising associated switch mechanisms and the relief formation of each surface portion determining whether the associated switch mechanism is switched.

30. The connection arrangement of claim 20 in which the sensing arrangement is in communication with a data processor, the data processor being operable to receive a signal from the sensing arrangement, compare said signal to stored data and determine how fluid quantity in a therapeutic inflatable cell apparatus is to be controlled.

31. A plug for attachment to a therapeutic inflatable cell apparatus, the plug being adapted to be connected to a socket of a fluid pump assembly, the plug being provided with at least one characteristic feature, said characteristic feature being indicative of a characteristic of the inflatable cell apparatus to which the plug is attached and, in use, when the plug is connection to the socket a sensing arrangement of the socket is arranged to sense the at least one characteristic feature.

32. A socket of a fluid pump assembly suitable for inflating a therapeutic inflatable cell apparatus, the socket being provided with a sensing arrangement, and in use the socket receiving a plug which plug is attached to the therapeutic inflatable cell apparatus, and the sensing arrangement being adapted To sense the at least one characteristic feature with which the plug is provided, the at least one characteristic feature being indicative of a characteristic of the inflatable cell apparatus which is attached to the plug.

33. A method of controlling fluid quantity in therapeutic inflatable apparatus comprising sensing at least one characteristic feature on a connector which is attached to the therapeutic inflatable cell apparatus, the characteristic feature being indicative of a characteristic of the therapeutic inflatable cell apparatus, transmitting a signal to a fluid pump control arrangement and controlling a volume of fluid in the garment in response to the at least one characteristic feature which was sensed.

34. Control assembly for pump apparatus, the pump apparatus being adapted to control fluid quantity in a therapeutic inflatable cell apparatus, the control assembly comprising a data processor and a data storage device, in use a signal is sent to the data processor from a sensing arrangement which is associated with a socket of the pump apparatus, the socket being adapted to receive a plug which is attached to a therapeutic inflatable cell apparatus, said plug and said socket providing fluid communication between the pump assembly and the therapeutic inflatable cell apparatus, the sensing arrangement generating a signal which is representative of at least one characteristic feature provided on the plug, said characteristic feature being indicative of a characteristic of the inflatable cell apparatus to which the plug is attached the data processor then being operative to compare said signal with data stored in the data storage device and determine how fluid in the therapeutic inflatable cell apparatus is to be controlled by the pump apparatus.

35. Control assembly as claimed in claim 34 wherein the data storage device is provided with predetermined control data.

36. Control assembly as claimed in claim 35 wherein the control data comprises a plurality of sets of control instructions.

37. Control assembly as claimed in claim 36 wherein each set of control instructions is associated with a respective at least one characteristic feature of a plug.

38. Control assembly as claimed in claim 37 wherein a set of control instructions causes the pump apparatus to control fluid quantity in a respective inflatable cell apparatus in a predetermined manner.

39. A method of controlling fluid quantity in therapeutic inflatable cell apparatus comprising measuring fluid pressure in at least part of the therapeutic inflatable cell apparatus and controlling the fluid quantity in response to pressure which has been measured.

40. A control assembly for therapeutic inflatable cell apparatus, the assembly comprising a pressure sensor, a data processor and a fluid control assembly, the data processor being configured to receive a feedback signal from the pressure sensor which is representative of a measurement of fluid pressure in a therapeutic inflatable cell apparatus, and said data processor being further configured to emit a control signal in response to the feedback signal, the control signal being sent to the fluid control assembly which is operative to control fluid quantity in the therapeutic cell apparatus.
